(19) United States
(12) Patent Application Publication
(10) Pub. No.: US 2020/0193430 A1
(43) Pub. Date: Jun. 18, 2020

(54) DETERMINING GENERATION TIME FOR BLOCKCHAIN DATA

(71) Applicant: Alibaba Group Holding Limited, George Town (KY)

(72) Inventor: Haitao Jiang, Hangzhou (CN)

(73) Assignee: Alibaba Group Holding Limited, George Town (KY)

(21) Appl. No.: 16/801,953

(22) Filed: Feb. 26, 2020

Related U.S. Application Data
(63) Continuation of application No. PCT/CN2020/070610, filed on Jan. 7, 2020.

(30) Foreign Application Priority Data
Apr. 30, 2019 (CN) 201910363186.X

(51) Int. Cl. G06Q 20/38

(52) U.S. Cl. CPC G06Q 20/3827

(57) ABSTRACT

Disclosed herein are methods, systems, and apparatuses, including computer programs encoded on computer storage media, for determining time for blockchain data. One of the methods includes: obtaining a first transaction identifier of a target transaction stored on a blockchain, wherein the target transaction comprises first target data, and wherein the first target data is generated by adding a second transaction identifier of a reference transaction stored on the blockchain to a second target data; obtaining, based on the first transaction identifier, a first timestamp corresponding to the target transaction; obtaining, based on the second transaction identifier, a second timestamp corresponding to the reference transaction; and determining, based on the first timestamp and the second timestamp, a time period during which the second target data was generated.

### CROSS-REFERENCE TO RELATED APPLICATIONS

This application is a continuation of PCT Application No. PCT/CN2020/070610, filed on Jan. 7, 2020, which claims priority to Chinese Patent Application No. 201910363186.X, filed on Apr. 30, 2019, and each application is hereby incorporated by reference in its entirety.

### TECHNICAL FIELD

One or more implementations of the present specification relate to the field of blockchain technologies, and in particular, to methods, apparatuses, and electronic devices for determining time for blockchain data.

### BACKGROUND

The blockchain technology, also referred to as a distributed ledger technology, is an emerging technology in which several computing devices jointly participate in recording a ledger and jointly maintain a complete distributed database. Due to its features of decentralization, openness and transparency, participation in database recording by each computing device, and fast data synchronization between computing devices, the blockchain technology has been widely used in various fields.

### SUMMARY

The present specification provides a method for determining time for blockchain data, where the method includes the following: adding, to target data, a first transaction identifier of a reference transaction stored on the blockchain; generating a target transaction, where the target transaction includes the target data to which the first transaction identifier is added; and publishing the generated target transaction to the blockchain for storage, and returning a second transaction identifier of the target transaction to a data verifier, where the data verifier queries, based on the second transaction identifier, a first timestamp corresponding to the target transaction stored on the blockchain, and then further queries, based on the first transaction identifier added to the target data, a second timestamp corresponding to the reference transaction stored on the blockchain, and determines a generation time period of the target data based on the first timestamp and the second timestamp.

Optionally, the transaction identifier is a hash value calculated for the transaction.

Optionally, the target transaction includes a hash value of the target data to which the first transaction identifier is added; and the generating a target transaction includes the following: calculating the hash value of the target data to which the first transaction identifier is added; and generating the target transaction based on the hash value of the target data to which the first transaction identifier is added.

Optionally, a timestamp corresponding to a transaction stored on the blockchain includes any one of the following: a timestamp corresponding to a block creation time of a block in which the transaction stored on the blockchain is located; a timestamp corresponding to a transaction creation time included in the transaction stored on the blockchain; or a timestamp corresponding to a transaction receiving time included in the transaction stored on the blockchain, where the timestamp corresponding to the transaction receiving time is added by a blockchain node in the blockchain network to the transaction when the transaction is received.

The present specification further provides a method for determining time for blockchain data, including the following: obtaining a second transaction identifier of a target transaction stored on the blockchain, where the target transaction includes target data to which a first transaction identifier of a reference transaction stored on the blockchain is added; querying, based on the second transaction identifier, a first timestamp corresponding to the target transaction stored on the blockchain, and after identifying the first timestamp corresponding to the target transaction, further querying, based on the first transaction identifier added to the target data, a second timestamp corresponding to the reference transaction stored on the blockchain; and determining a generation time period of the target data based on the first timestamp and the second timestamp.

Optionally, the transaction identifier is a hash value calculated for the transaction.

Optionally, the target transaction includes a hash value of the target data to which the first transaction identifier is added; and the querying, based on the second transaction identifier, a first timestamp corresponding to the target transaction stored on the blockchain includes the following: querying, based on the second transaction identifier, the target transaction stored on the blockchain; obtaining a first query result returned by a blockchain node in the blockchain network, where the first query result includes the hash value of the target data and the first timestamp corresponding to the target transaction; and obtaining the first timestamp from the first query result.

Optionally, a data verifier locally stores the target data to which the first transaction identifier is added; and the querying, based on the first transaction identifier added to the target data, a second timestamp corresponding to the reference transaction stored on the blockchain includes the following: calculating the hash value of the locally stored target data; determining whether the calculated hash value matches the hash value of the target data in the first query result, and if yes, further reading the first transaction identifier added to the locally stored target data; querying, based on the read first transaction identifier, the reference transaction stored on the blockchain; obtaining a second query result returned by the blockchain node in the blockchain network, where the second query result includes the second timestamp corresponding to the reference transaction; and obtaining the second timestamp from the second query result.

Optionally, the determining a generation time period of the target data based on the first timestamp and the second timestamp includes the following: determining a time period after a first time corresponding to the first timestamp and before a second time corresponding to the second timestamp as the generation time period of the target data.

Optionally, a timestamp corresponding to a transaction stored on the blockchain includes any one of the following: a timestamp corresponding to a block creation time of a block in which the transaction stored on the blockchain is located; a timestamp corresponding to a transaction creation time included in the transaction stored on the blockchain; or a timestamp corresponding to a transaction receiving time included in the transaction stored on the blockchain, where the timestamp corresponding to the transaction receiving time is added by the blockchain node in the blockchain network to the transaction when the transaction is received.

The present specification further provides an apparatus for determining time for blockchain data, where the apparatus includes the following: an adding module, configured to add, to target data, a first transaction identifier of a reference transaction stored on the blockchain; a generation module, configured to generate a target transaction, where the target transaction includes the target data to which the first transaction identifier is added; and a storage module, configured to publish the generated target transaction to the blockchain for storage, and return a second transaction identifier of the target transaction to a data verifier, where the data verifier queries, based on the second transaction identifier, a first timestamp corresponding to the target transaction stored on the blockchain, and then further queries, based on the first transaction identifier added to the target data, a second timestamp corresponding to the reference transaction stored on the blockchain, and determines a generation time period of the target data based on the first timestamp and the second timestamp.

Optionally, the transaction identifier is a hash value calculated for the transaction.

Optionally, the target transaction includes a hash value of the target data to which the first transaction identifier is added; and the generation module is configured to: calculate the hash value of the target data to which the first transaction identifier is added; and generate the target transaction based on the hash value of the target data to which the first transaction identifier is added.

Optionally, a timestamp corresponding to a transaction stored on the blockchain includes any one of the following: a timestamp corresponding to a block creation time of a block in which the transaction stored on the blockchain is located; a timestamp corresponding to a transaction creation time included in the transaction stored on the blockchain; or a timestamp corresponding to a transaction receiving time included in the transaction stored on the blockchain, where the timestamp corresponding to the transaction receiving time is added by the blockchain node in the blockchain network to the transaction when the transaction is received.

The present specification further provides an apparatus for determining time for blockchain data, including the following: an acquisition module, configured to obtain a second transaction identifier of a target transaction stored on the blockchain, where the target transaction includes target data to which a first transaction identifier of a reference transaction stored on the blockchain is added; a query module, configured to query, based on the second transaction identifier, a first timestamp corresponding to the target transaction stored on the blockchain, and after identifying the first timestamp corresponding to the target transaction, further query, based on the first transaction identifier added to the target data, a second timestamp corresponding to the reference transaction stored on the blockchain; and a determining module, configured to determine a generation time period of the target data based on the first timestamp and the second timestamp.

Optionally, the transaction identifier is a hash value calculated for the transaction.

Optionally, the target transaction includes a hash value of the target data to which the first transaction identifier is added; and the query module is configured to: query, based on the second transaction identifier, the target transaction stored on the blockchain; obtain a first query result returned by a blockchain node in the blockchain network, where the first query result includes the hash value of the target data and the first timestamp corresponding to the target transaction; and obtain the first timestamp from the first query result.

Optionally, a data verifier locally stores the target data to which the first transaction identifier is added; and the query module is further configured to: calculate the hash value of the locally stored target data; determine whether the calculated hash value matches the hash value of the target data in the first query result, and if yes, further read the first transaction identifier added to the locally stored target data; query, based on the read first transaction identifier, the reference transaction stored on the blockchain; obtain a second query result returned by the blockchain node in the blockchain network, where the second query result includes the second timestamp corresponding to the reference transaction; and obtain the second timestamp from the second query result.

Optionally, the determining module is configured to: determine a time period after a first time corresponding to the first timestamp and before a second time corresponding to the second timestamp as the generation time period of the target data.

Optionally, a timestamp corresponding to a transaction stored on the blockchain includes any one of the following: a timestamp corresponding to a block creation time of a block in which the transaction stored on the blockchain is located; a timestamp corresponding to a transaction creation time included in the transaction stored on the blockchain; or a timestamp corresponding to a transaction receiving time included in the transaction stored on the blockchain, where the timestamp corresponding to the transaction receiving time is added by the blockchain node in the blockchain network to the transaction when the transaction is received.

In the previous technical solutions, the transaction identifier of the reference transaction stored on the blockchain is added to the target data whose certificate is to be stored, and then the target data to which the transaction identifier is added is published to the blockchain for storage, so that the verifier of the target data can determine the generation time period of the target data by querying the first timestamp of the target data stored on the blockchain and the second timestamp of the reference transaction added to the target data. As such, the real generation time period of the target data stored on the blockchain can be determined.

### BRIEF DESCRIPTION OF DRAWINGS

FIG. 1 is a flowchart illustrating a method for determining time for blockchain data, according to an example implementation;

FIG. 2 is a structural diagram illustrating a blockchain-based judicial storage system, according to an example implementation;

FIG. 3 is an interactive diagram of performing judicial evidence verification based on the judicial storage system shown in FIG. 2, according to an example implementation;

FIG. 4 is a schematic structural diagram illustrating an electronic device, according to an example implementation;

FIG. 5 is a block diagram illustrating an apparatus for determining time for blockchain data, according to an example implementation; and

FIG. 6 is a block diagram illustrating another apparatus for determining time for blockchain data, according to an example implementation.

### DESCRIPTION OF IMPLEMENTATIONS

Example implementations are described in detail here with accompanying drawings. When the following description relates to the accompanying drawings, unless specified otherwise, same numbers in different accompanying drawings represent same or similar elements. Example implementations described in the following do not represent all implementations consistent with one or more implementations of the present specification. On the contrary, the implementations are only examples of apparatuses and methods that are described in the appended claims in detail and consistent with some aspects of one or more implementations of the present specification.

It is worthwhile to note that the steps of the corresponding methods are not necessarily performed in the order shown and described in the present specification. In some implementations, the method can include more or less steps than those described in the present specification. In addition, a single step described in the present specification can be decomposed into multiple steps in other implementations for the purpose of illustrations, and multiple steps described in the present specification may be combined into a single step in some implementations.

Blockchains are generally categorized into three types: public blockchain, private blockchain, and consortium blockchain. In addition, there are multiple types of combinations, such as a combination of private blockchain and consortium blockchain, or a combination of consortium blockchain and public blockchain, etc. The public blockchain has the highest degree of decentralization. Example public blockchains can include bitcoins and Ethereum. Participants joining the public blockchain can read data records on the blockchain, participate in transactions, and contend for the mining right in new blocks.

Furthermore, participants (i.e., blockchain nodes) can join or exit the blockchain network freely and perform related operations. On the contrary, in the private blockchain, write permissions of the blockchain network are controlled by a certain organization or institution, and the data read permissions are specified by the organization. In short, the private blockchain can be a weakly-centralized system. There are a few participating nodes that are strictly restricted. Such type of blockchain is more suitable for use within a particular institution.

Fundamentally, the blockchain usually comprises several blocks. Each of these blocks records a timestamp corresponding to a creation time of the block. All the blocks form a temporally ordered data chain by strictly following the timestamps recorded in the blocks.

Real data generated in the physical world can be constructed as a standard transaction supported by the blockchain, and then published to the blockchain. Blockchain nodes in the blockchain network perform consensus, and after the consensus is reached, a blockchain node serving as a bookkeeping node in the blockchain network packages the transaction into a block for permanent storage on the blockchain.

However, when data generated in the physical world is published to a block on the blockchain in the form of a transaction for permanent storage, usually only the generation time of the data can be determined based on the information recorded on the blockchain. The generation time is earlier than the creation time of the block in which the data is located.

In some practical application scenarios, it may be necessary to learn a more specific generation time of the data stored on the blockchain.

For example, in an application scenario where a signed electronic contract is published to the blockchain for storage, because the electronic contract is a legally effective document, when the electronic contract is used as a judicial evidence, it is insufficient to only learn that the electronic contract was signed at a certain time earlier than the creation time of the block that records the electronic contract, and it is usually necessary to learn whether the electronic contract was signed within a specific time period.

In view of the previous description, the present specification provides a technical solution for determining an accurate generation time period for data stored on the blockchain.

During implementation, when needing to publish generated target data to the blockchain for storage, a user can submit original content of the target data to a storage client. When receiving the target data submitted by the user, the storage client can obtain a first transaction identifier of a reference transaction stored on the blockchain, and then add the first transaction identifier to the original content of the target data.

When the first transaction identifier is added to the target data, the storage client can further construct a target transaction based on the target data and the standard transaction format supported by the blockchain, publish the target transaction to the blockchain for storage, and return a second transaction identifier of the target transaction to the data verifier.

When needing to verify the generation time period of the target data, the data verifier can first initiate a query on the blockchain based on the second transaction identifier to query the first timestamp corresponding to the previous target transaction stored on the blockchain.

After identifying the first timestamp corresponding to the target transaction stored on the blockchain, the data verifier can further initiate a query on the blockchain based on the first transaction identifier of the previous reference transaction added to the original content of the target data, to query the second timestamp corresponding to the reference transaction stored on the blockchain.

After identifying the first timestamp and the second timestamp, the data verifier can determine the generation time period of the target data based on the first timestamp and the second timestamp.

For example, in an example, a time period after a first time corresponding to the first timestamp and before a second time corresponding to the second timestamp can be determined as the generation time period of the target data.

In the previous technical solutions, the transaction identifier of the reference transaction stored on the blockchain is added to the target data whose certificate is to be stored, and then the target data to which the transaction identifier is added is published to the blockchain for storage, so that the verifier of the target data can determine the generation time period of the target data by querying the first timestamp of the target data stored on the blockchain and the second timestamp of the reference transaction added to the target data. As such, the real generation time period of the target data stored on the blockchain can be determined.

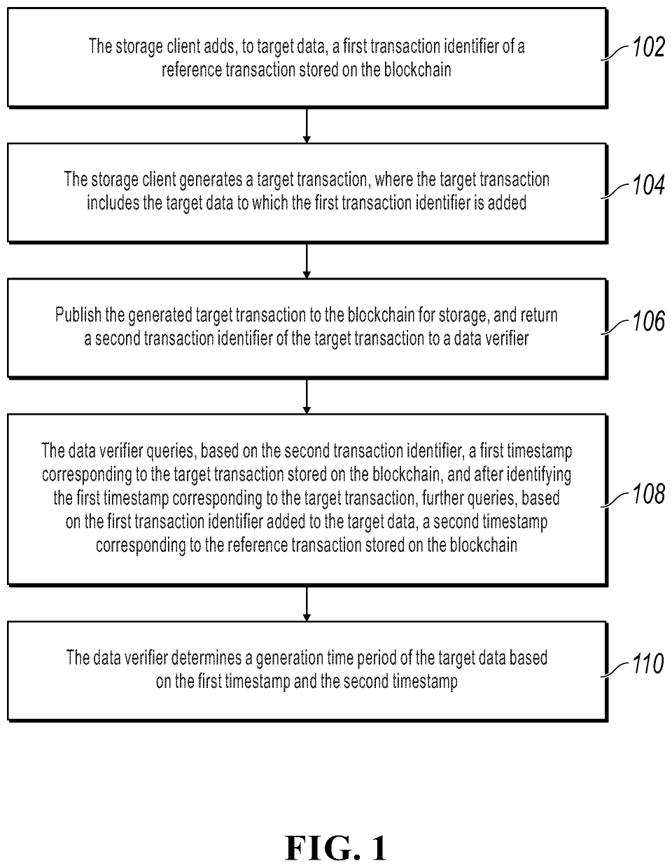

FIG. 1 is a flowchart illustrating a method for determining time for blockchain data, according to an example implementation. The method is applied to the storage client and the data verifier, and includes the following steps:

Step 102: The storage client adds, to target data, a first transaction identifier of a reference transaction stored on the blockchain.

Step 104: The storage client generates a target transaction, where the target transaction includes the target data to which the first transaction identifier is added.

Step 106: Publish the generated target transaction to the blockchain for storage, and return a second transaction identifier of the target transaction to the data verifier.

Step 108: The data verifier queries, based on the second transaction identifier, a first timestamp corresponding to the target transaction stored on the blockchain, and after identifying the first timestamp corresponding to the target transaction, further queries, based on the first transaction identifier added to the target data, a second timestamp corresponding to the reference transaction stored on the blockchain.

Step 110: The data verifier determines a generation time period of the target data based on the first timestamp and the second timestamp.

The previous target data includes any form of data that is generated in the physical world and needs to be permanently stored as evidence in a distributed ledger of the blockchain.

For example, in a judicial storage scenario, the previous target data can include picture data, video data, electronic contract data, etc. that needs to be used as evidence for storage on the blockchain.

In practice, as an operation portal for data storage on the blockchain by a user, the storage client can include a native application developed based on an advanced programming language, or developed by using a mixed development model of an advanced programming language and a web programming language; or can be a web application developed by using a web programming language.

For example, in practice, the storage client can be a mobile APP or a web application (such as a browser).

The data verifier is a party that needs to verify data stored on the blockchain. In the present specification, the data verifier can perform verification to determine whether the data stored on the blockchain is generated in a specific time period.

For example, in the judicial storage scenario, the data verifier can include a verification system, a verification device, etc. deployed by a judicial organization for verifying validity of data stored on the blockchain as judicial evidence. The judicial organization can verify the data stored on the blockchain as judicial evidence by using the deployed verification system, verification device, etc., to determine whether the data is generated in a specific time period.

The following describes the technical solutions in the present specification in detail by using an application scenario of judicial storage as an example. It is worthwhile to note that the application scenario of judicial storage is merely used as an example. In practice, the technical solutions in the present specification can also be clearly applied to other similar data storage scenarios, which are not enumerated one by one in the present specification.

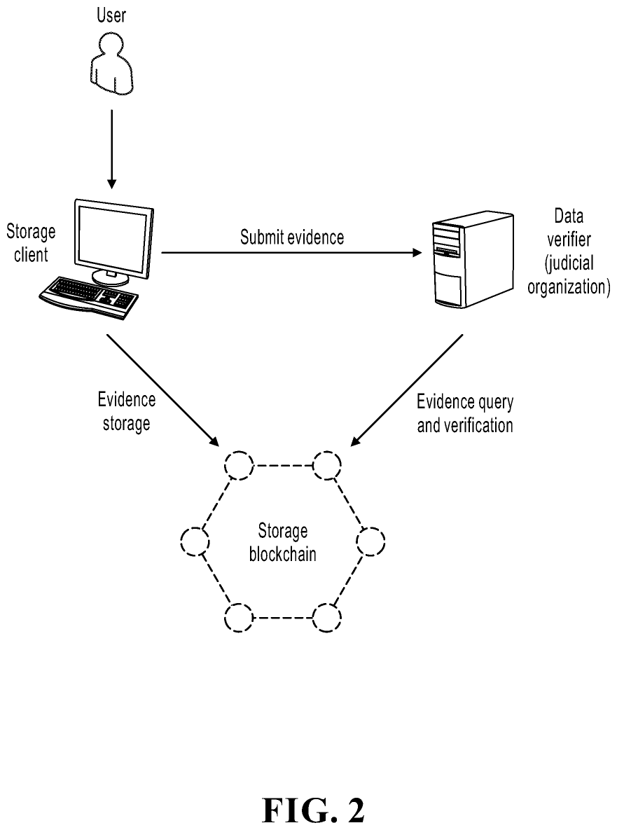

FIG. 2 is a structural diagram illustrating a blockchain-based judicial storage system, according to the present specification.

As shown in FIG. 2, on the one hand, a user initiating storage can publish target data as judicial evidence to the blockchain for storage by using the storage client. On the other hand, the user can submit the target data as judicial evidence to the judicial organization.

As a data verifier, the judicial organization can query the judicial evidence stored on the blockchain, and verify the judicial evidence submitted by the user based on the identified judicial evidence, for example, verify whether the judicial evidence submitted by the user is legitimate or tampered with; and verify whether the judicial evidence submitted by the user is generated in a specific time period.

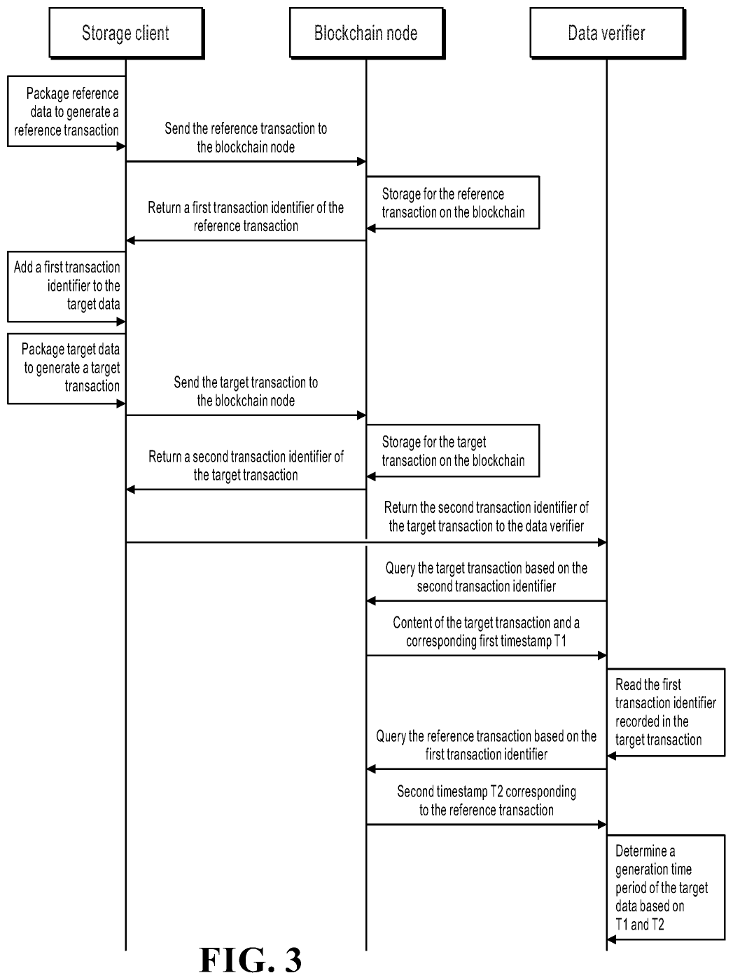

FIG. 3 is an interactive diagram of performing judicial evidence verification based on the judicial storage system shown in FIG. 2, according to the present specification.

It is worthwhile to note that, the judicial storage process described in the present specification includes two stages: storage for reference data and storage for target data as judicial evidence.

As shown in FIG. 3, at the stage of storage for reference data, a user initiating storage can package reference data to generate a reference transaction by using the storage client, and send the packaged reference transaction to a blockchain node connected to the storage client.

The previous reference data can include any content, which is not limited in the present specification.

After receiving the reference transaction from the client, the blockchain node in the blockchain network can check whether the transaction is valid and whether a format of the transaction is correct, and verify whether a signature of the transaction is legitimate, and so on; initiate consensus on the received reference transaction based on a consensus algorithm supported by the blockchain after all checking and verification succeed; and permanently store the reference transaction in a distributed ledger of the blockchain after the consensus is reached, to complete the process of storage for the reference transaction on the blockchain.

When the storage for the reference transaction on the blockchain succeeds, the blockchain node in the blockchain network can return a storage result corresponding to the reference transaction to the storage client, and the storage client stores the storage result, and outputs the storage result to the user through a visual user interface.

For example, in practice, the storage result can be a storage receipt returned by the blockchain node in the blockchain network after a certificate of the data is successfully stored on the blockchain. The storage receipt can include information such as a transaction identifier of the transaction generated by packaging the data, a block height (i.e., block number) of a block in which the transaction is located on the blockchain, a timestamp corresponding to a storage time of the transaction on the blockchain, etc.

Referring back to FIG. 3, at the stage of storage for target data as judicial evidence, a user initiating storage can first submit the target data that needs to be used as judicial evidence to the storage client. After receiving the target data submitted by the user, the storage client can add, to the previous target data, the transaction identifier (i.e., the first transaction identifier) of the previous reference transaction stored on the blockchain.

A specific method for adding the transaction identifier of the reference transaction to the target data is not specially limited in the present specification.

For example, the target data is an electronic contract that serves as judicial evidence. The storage client can visually process the transaction identifier of the reference transaction and convert the transaction identifier into a graphic identifier (such as a watermark or a two-dimensional code), and then overlay the graphic identifier over the contract content of the electronic contract.

It is worthwhile to note that, in practice, the above-described stage of storage for reference data can be omitted. In such case, before receiving the target data submitted by the user initiating storage, the storage client can initiate one query to the blockchain to randomly obtain a transaction successfully stored on the blockchain as a reference transaction, and add a transaction identifier of the obtained reference transaction to the previous target data.

Further, after adding the transaction identifier of the reference transaction to the target data, the storage client can package the target data to which the transaction identifier of the reference transaction is added, to generate a target transaction, and send the packaged target transaction to the blockchain node connected to the storage client.

After receiving the target transaction from the client, the blockchain node in the blockchain network can still check whether the transaction is valid and whether a format of the transaction is correct, and verify whether a signature of the transaction is legitimate, and so on; initiate consensus on the received target transaction based on a consensus algorithm supported by the blockchain after all checking and verification succeed; and permanently store the target transaction in a distributed ledger of the blockchain after the consensus is reached, to complete the process of storage for the target transaction on the blockchain.

The consensus algorithm supported by the blockchain is not specially limited in the present specification.

Generally, the consensus algorithm supported by the blockchain includes a consensus algorithm in which a blockchain node needs to contend for the mining right of each round of accounting period, and a consensus algorithm in which a bookkepping node is elected in advance for each round of accounting period (there is no need to contend for the mining right).

For example, the former is represented by consensus algorithms such as Proof of Work (POW), Proof of Stake (POS), and Delegated Proof of Stake (DPOS). The latter is represented by consensus algorithms such as Practical Byzantine Fault Tolerance (PBFT).

In a blockchain network using consensus algorithms such as POW, POS, and DPOS, blockchain nodes in the blockchain network can contend for the mining right. Any blockchain node winning the current round of mining right contention can become a bookkeeping node. The bookkeeping node can package the received transaction from the client together with other transactions to generate a new block, and send the generated new block to other nodes for consensus.

In a blockchain network using the consensus algorithms such as PBFT, the node having the mining right has been agreed on before the current round of accounting. Therefore, after receiving a transaction from the client, the blockchain node can further send the transaction to the bookkeeping node if the blockchain node is not the bookkeeping node of the current round. The bookkeeping node of the current round can package the transaction together with other transactions to generate a new block, and then can send the generated new block or a block header of the generated new block to other nodes for consensus verification.

As described above, regardless of which type of consensus algorithm shown above is used by the blockchain, the bookkeeping node of the current round can package the received transaction to generate the new block, and send the generated new block or the block header to other blockchain nodes for consensus verification. If the verification on the new block or the block header received by other blockchain nodes succeeds, the new block can be appended to the end of the original blockchain, thereby completing the accounting process and reaching consensus. After consensus is reached, the data included in the transaction will be permanently stored in the distributed ledger of the blockchain. In other words, after consensus is reached, the process of storage for the data included in the transaction is completed on the blockchain.

When the storage for the target transaction on the blockchain succeeds, the blockchain node in the blockchain network can return a storage result corresponding to the target transaction to the storage client.

After receiving the storage result corresponding to the target transaction returned by the blockchain node in the blockchain network, the storage client needs to store the storage result and output the storage result to the user through a visual user interface, and can further return the transaction identifier of the target transaction in the storage result to the data verifier. The data verifier verifies the target data that serves as judicial evidence.

In some implementations, the transaction identifier of the transaction stored on the blockchain can be a hash value obtained by performing hash calculation on the transaction as a whole.

In such case, when adding the transaction identifier of the reference transaction to the target data, the storage client can add the hash value of the reference transaction to the target data as the transaction identifier. After a certificate of the target transaction has been successfully stored on the blockchain, the hash value of the target transaction is returned to the data verifier.

In practice, the transaction identifier of the transaction stored on the blockchain can be any form of identifier allocated by the blockchain node in the blockchain network, for example, a transaction number allocated by the blockchain node, etc., which is not listed one by one in the present specification.

In the present specification, because the target data that serves as judicial evidence possibly includes privacy data of the user and the blockchain serves as a completely transparent and open distributed ledger, after a certificate of plaintext content of the target data is stored on the blockchain, privacy of the user may be leaked.

In view of the previous description, in some implementations, when publishing the target data that serves as judicial evidence to the blockchain for storage, the user can publish only the hash value of the target data instead of the plaintext content of the target blockchain data for storage.

In such case, after receiving the target data submitted by the user and adding the transaction identifier of the reference transaction to the target data, the storage client can calculate a hash value of the target data to which the transaction identifier of the reference transaction is added, and then package the generated hash value to generate the target transaction. To be specific, the target transaction generated through packaging includes only the hash value of the target data, and does not include the plaintext content of the target data.

Correspondingly, after receiving the storage result corresponding to the target transaction returned by the blockchain node in the blockchain network, the storage client needs to return the transaction identifier of the target transaction in the storage result to the data verifier, and further needs to submit the plaintext content of the target data to the data verifier.

In other words, because only the hash value of the target data is published to the blockchain for storage, the data verifier cannot obtain the plaintext content of the target data directly from the blockchain. Therefore, the user needs to submit the plaintext content of the target data together with the transaction identifier of the target transaction to the data verifier by using the storage client for data verification.

In the following implementations, an example in which the storage client publishes only the hash value of the target data to the blockchain for storage will be described.

Certainly, it is worthwhile to note that, in practice, the storage client can also directly publish the plaintext content of the target data to the blockchain for storage when the target data does not involve the privacy of the user.

In the present specification, after receiving the transaction identifier of the target transaction returned by the storage client, the data verifier can query the target transaction stored on the blockchain based on the transaction identifier of the target transaction, and obtain a query result returned by the blockchain node in the blockchain network.

The hash value of the transaction identifier is used as an example. The data verifier can submit the hash value of the target transaction as a parameter to a data access API interface enabled on the blockchain node in the blockchain network, initiate an interface call to the API interface, and then obtain the target transaction stored on the blockchain based on a calling return of the API interface.

The query result corresponding to the target transaction returned by the blockchain node usually includes the hash value of the target transaction (that is, the data content included in the target transaction) and the storage timestamp corresponding to the target transaction (that is, the previous first timestamp). After receiving the query result corresponding to the target transaction returned by the blockchain node, the data verifier can obtain the storage timestamp corresponding to the target transaction included in the query result.

Further, after receiving the query result returned by the blockchain node and obtaining the storage timestamp corresponding to the target transaction included in the query result, the data verifier can further read the hash value of the target transaction included in the query result, and calculate the hash value of the plaintext content of the target data that is locally stored by the data verifier and submitted by the storage client. Then, the data verifier can determine whether the calculated hash value matches the hash value included in the query result returned by the blockchain node.

If the previous two hash values do not match, it indicates that the plaintext content of the target data submitted by the storage client does not match the target data stored on the blockchain, and the target data submitted by the storage client may be tampered by illegitimate content. In such case, the data verifier can directly terminate the verification process for the target data.

If the previous two hash values match, it indicates that the target data submitted by the storage client succeeds in validity verification. In such case, the data verifier can further read the transaction identifier of the reference transaction recorded in the locally stored target data, query the reference transaction stored on the blockchain based on the read transaction identifier of the reference transaction, and obtain the query result returned by the blockchain node in the blockchain network. The specific query process is omitted here for simplicity.

The query result corresponding to the reference transaction returned by the blockchain node can still include the data content included in the reference transaction (or the hash value of the reference transaction) and the storage timestamp (that is, the previous second timestamp) corresponding to the reference transaction. After receiving the query result corresponding to the reference transaction returned by the blockchain node, the data verifier can obtain the storage timestamp corresponding to the reference transaction included in the query result.

In the present specification, after obtaining the storage timestamp (denoted as the first timestamp) corresponding to the target transaction and the storage timestamp (denoted as the second timestamp) corresponding to the reference transaction, because a storage time of the reference transaction on the blockchain is earlier than a storage time of the target transaction on the blockchain, the data verifier can determine a time period after a first time corresponding to the first timestamp and before a second time corresponding to the second timestamp as a generation time period of the target data when determining the generation time period of the target data based on the first timestamp and the second timestamp.

A method for representing the generation time period of the target data is not specially limited in the present specification. For example, assume that the time corresponding to the first timestamp is denoted as T1 and the time corresponding to the second timestamp is denoted as T2. The generation time period of the target data can be represented as [T1, T2]. That is, the above-described time period is represented by using a closed interval. Certainly, in practice, the generation time period of the target data can be represented as [T1, T2), (T1, T2], and (T1, T2).

It is worthwhile to note that, as described in the previous implementations, a storage timestamp corresponding to a transaction stored on the blockchain is a timestamp that is recorded in a distributed ledger on the blockchain and can reflect a storage time of the transaction on the blockchain.

The method for representing the storage timestamp corresponding to the transaction stored on the blockchain is not specially limited in the present specification. A person skilled in the art can represent the storage timestamp by using any one of the timestamp corresponding to the block creation time of the block in which the transaction is located, the timestamp corresponding to the transaction creation time, or the timestamp corresponding to the transaction receiving time.

In some implementations, the storage timestamp corresponding to the transaction stored on the blockchain can be the timestamp corresponding to the block creation time of the block in which the transaction stored on the blockchain is located. The timestamp corresponding to the block creation time is usually recorded in the block header of the block.

In such case, when the data verifier queries the storage timestamp of the target transaction or the reference transaction from the blockchain, the blockchain node can read timestamp information directly from the block header of the block in which the target transaction or the reference transaction is located, and then return the timestamp information as a query result to the data verifier.

In some other implementations, the storage timestamp corresponding to the transaction stored on the blockchain can also be the timestamp corresponding to the transaction creation time included in the transaction stored on the blockchain.

In such case, when packaging the previous reference data or target data to generate a transaction, the storage client can directly obtain a current system time as the transaction creation time, and then convert the current system time into a timestamp and include the timestamp in the transaction generated through packaging.

When the data verifier queries the storage timestamp of the target transaction or the reference transaction from the blockchain, the blockchain node can read the included timestamp corresponding to the transaction creation time directly from the target transaction or the reference transaction, and then return the timestamp as a query result to the data verifier.

In some other implementations, the storage timestamp corresponding to the transaction stored on the blockchain can also be the timestamp corresponding to the transaction receiving time included in the transaction stored on the blockchain, where the timestamp corresponding to the transaction receiving time can be added by the blockchain node in the blockchain network to the transaction when the transaction is received.

In other words, when packaging the previous reference data or target data to generate a transaction, the storage client may no longer need to include the current system timestamp as the transaction creation time in the transaction. Instead, when the transaction generated through packaging is sent to the blockchain node in the blockchain network, the blockchain node in the blockchain network determines the transaction receiving time by using an agreed distributed clock on the blockchain, and then adds the timestamp corresponding to the transaction receiving time to the transaction.

In the previous technical solutions, the transaction identifier of the reference transaction stored on the blockchain is added to the target data whose certificate is to be stored, and then the target data to which the transaction identifier is added is published to the blockchain for storage, so that the verifier of the target data can determine the generation time period of the target data by querying the first timestamp of the target data stored on the blockchain and the second timestamp of the reference transaction added to the target data. As such, the real generation time period of the target data stored on the blockchain can be determined.

Corresponding to the previous method implementation, the present application further provides an apparatus implementation.

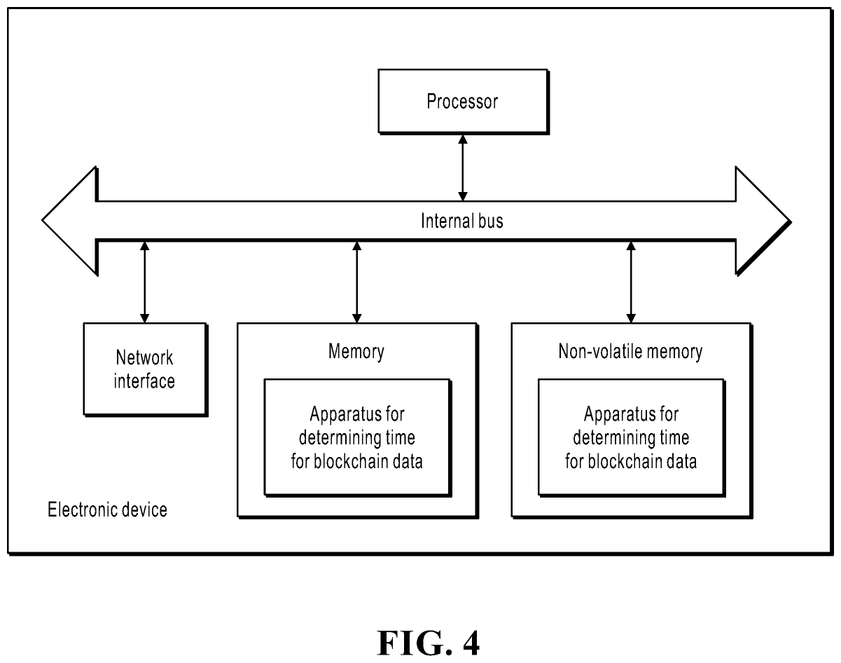

Corresponding to the previous method implementation, the present specification further provides an implementation of an apparatus for determining time for blockchain data. The implementation of the apparatus for determining time for blockchain data in the present specification can be applied to an electronic device. The apparatus implementation can be implemented by software, or can be implemented by hardware or a combination of software and hardware. For example, the apparatus implementation is implemented by software. A logical apparatus is formed when a processor of an electronic device where the apparatus is located reads a corresponding computer program instruction in a non-volatile memory into the memory for running. In terms of hardware, FIG. 4 is a diagram of a hardware structure of an electronic device in which an apparatus for determining time for blockchain data is located, according to the present specification. In addition to the processor, memory, network interface, and non-volatile memory shown in FIG. 4, the electronic device in which the apparatus is located in the implementation generally can further include other hardware based on an actual function of the electronic device. Details are omitted here for simplicity.

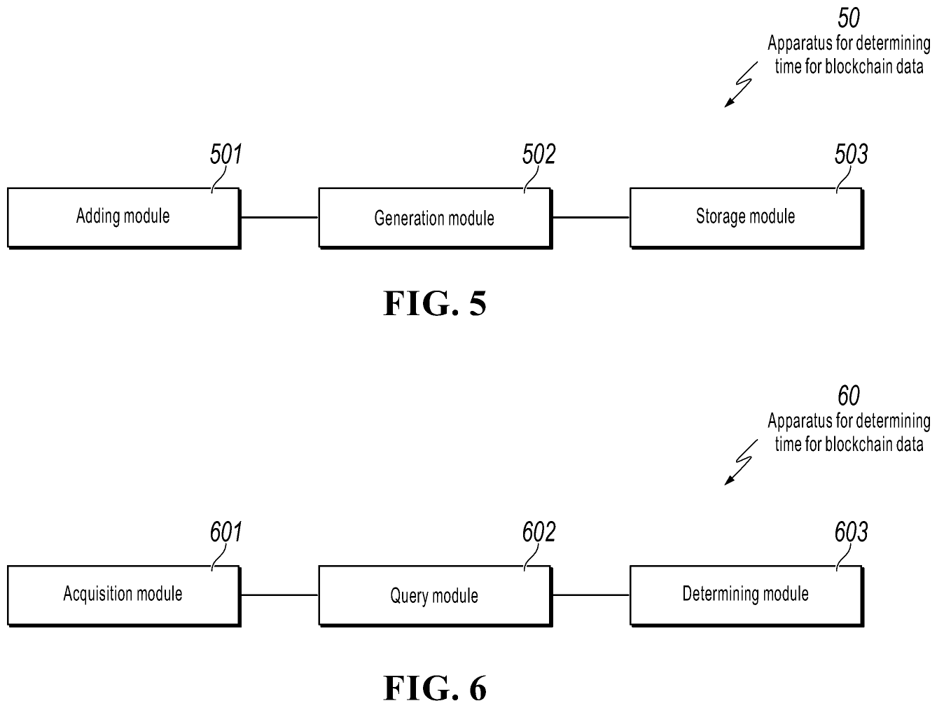

FIG. 5 is a block diagram illustrating an apparatus for determining time for blockchain data, according to an example implementation of the present specification.

Referring to FIG. 5, the apparatus 50 for determining time for blockchain data can be applied to the electronic device shown in FIG. 4. The apparatus 50 includes the following: an adding module 501, configured to add, to target data, a first transaction identifier of a reference transaction stored on the blockchain; a generation module 502, configured to generate a target transaction, where the target transaction includes the target data to which the first transaction identifier is added; and a storage module 503, configured to publish the generated target transaction to the blockchain for storage, and return a second transaction identifier of the target transaction to a data verifier, where the data verifier queries, based on the second transaction identifier, a first timestamp corresponding to the target transaction stored on the blockchain, and then further queries, based on the first transaction identifier added to the target data, a second timestamp corresponding to the reference transaction stored on the blockchain, and determines a generation time period of the target data based on the first timestamp and the second timestamp.

In the present implementation, the transaction identifier is a hash value calculated for the transaction.

In the present implementation, the target transaction includes a hash value of the target data to which the first transaction identifier is added; the generation module 502 is configured to: calculate the hash value of the target data to which the first transaction identifier is added; and generate the target transaction based on the hash value of the target data to which the first transaction identifier is added.

In the present implementation, a timestamp corresponding to a transaction stored on the blockchain includes any one of the following: a timestamp corresponding to a block creation time of a block in which the transaction stored on the blockchain is located; a timestamp corresponding to a transaction creation time included in the transaction stored on the blockchain; or a timestamp corresponding to a transaction receiving time included in the transaction stored on the blockchain, where the timestamp corresponding to the transaction receiving time is added by the blockchain node in the blockchain network to the transaction when the transaction is received.

FIG. 6 is a block diagram illustrating an apparatus for determining time for blockchain data, according to an example implementation of the present specification.

Referring to FIG. 6, the apparatus 60 for determining time for blockchain data can also be applied to the electronic device shown in FIG. 3. The apparatus 60 includes the following: an acquisition module 601, configured to obtain a second transaction identifier of a target transaction stored on the blockchain, where the target transaction includes target data to which a first transaction identifier of a reference transaction stored on the blockchain is added; a query module 602, configured to query, based on the second transaction identifier, a first timestamp corresponding to the target transaction stored on the blockchain, and after identifying the first timestamp corresponding to the target transaction, further query, based on the first transaction identifier added to the target data, a second timestamp corresponding to the reference transaction stored on the blockchain; and a determining module 603, configured to determine a generation time period of the target data based on the first timestamp and the second timestamp.

In the present implementation, the transaction identifier is a hash value calculated for the transaction.

In the present implementation, the target transaction includes a hash value of the target data to which the first transaction identifier is added; the query module 602 is configured to: query, based on the second transaction identifier, the target transaction stored on the blockchain; obtain a first query result returned by a blockchain node in the blockchain network, where the first query result includes the hash value of the target data and the first timestamp corresponding to the target transaction; and obtain the first timestamp from the first query result.

In the present implementation, a data verifier locally stores the target data to which the first transaction identifier is added; the query module 602 is further configured to: calculate the hash value of the locally stored target data; determine whether the calculated hash value matches the hash value of the target data in the first query result, and if yes, further read the first transaction identifier added to the locally stored target data; query, based on the read first transaction identifier, the reference transaction stored on the blockchain; obtain a second query result returned by the blockchain node in the blockchain network, where the second query result includes the second timestamp corresponding to the reference transaction; and obtain the second timestamp from the second query result.

In the present implementation, the determining module 603 is configured to: determine a time period after a first time corresponding to the first timestamp and before a second time corresponding to the second timestamp as the generation time period of the target data.

In the present implementation, a timestamp corresponding to a transaction stored on the blockchain includes any one of the following: a timestamp corresponding to a block creation time of a block in which the transaction stored on the blockchain is located; a timestamp corresponding to a transaction creation time included in the transaction stored on the blockchain; or a timestamp corresponding to a transaction receiving time included in the transaction stored on the blockchain, where the timestamp corresponding to the transaction receiving time is added by the blockchain node in the blockchain network to the transaction when the transaction is received.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, a computer includes one or more processors (CPU), one or more input/output interfaces, one or more network interfaces, and one or more memories.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by the computing device. Based on the definition in the present specification, the computer readable medium does not include transitory media such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more implementations of the present specification are merely used to describe specific implementations, and are not intended to limit the one or more implementations of the present specification. The terms “a” and “the” of singular forms used in one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. can be used in one or more implementations of the present specification to describe various types of information, the information is not limited to these terms. These terms are only used to differentiate between information of the same type. For example, without departing from the scope of one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

What is claimed is:

1. A computer-implemented method for determining time for blockchain data, comprising:
obtaining a first transaction identifier of a target transaction stored on a blockchain, wherein the target transaction comprises first target data, and wherein the first target data is generated by adding a second transaction identifier of a reference transaction stored on the blockchain to a second target data;
obtaining, based on the first transaction identifier, a first timestamp corresponding to the target transaction;
obtaining, based on the second transaction identifier, a second timestamp corresponding to the reference transaction; and
determining, based on the first timestamp and the second timestamp, a time period during which the second target data was generated.

2. The computer-implemented method of claim 1, wherein the first transaction identifier is a hash value of the reference transaction and the second transaction identifier is a hash value of the target transaction.

3. The computer-implemented method of claim 1, wherein the target transaction comprises a hash value of the first target data, and obtaining the first timestamp comprises:
identifying, based on the first transaction identifier, the target transaction; and
receiving, from a blockchain node associated with the blockchain, the hash value of the first target data and the first timestamp corresponding to the target transaction.

4. The computer-implemented method of claim 3, wherein a local version of the first target data is stored by a data verifier, and obtaining the second timestamp comprises:
calculating a hash value of the local version;
determining that the hash value of the local version is same as a hash value of the first target data;
identify the first transaction identifier from the local version;
identifying, based on the first transaction identifier, the reference transaction stored on the blockchain; and
obtaining the second timestamp corresponding to the reference transaction.

5. The computer-implemented method of claim 1, wherein the time period is between a time of the first timestamp and a time of the second timestamp.

6. The computer-implemented method of claim 1, wherein the first timestamp is one of:
a timestamp corresponding to a creation time of a block that includes the target transaction, a timestamp corresponding to a creation time of the target transaction included in the target transaction, or a timestamp corresponding to a receiving time of the target transaction included in the target transaction; and
wherein the timestamp corresponding to the receiving time of the target transaction is added by a blockchain node associated with the blockchain when the target transaction is received by the blockchain node.

7. The computer-implemented method of claim 1, wherein the second timestamp is one of:
a timestamp corresponding to a creation time of a block that includes the reference transaction, a timestamp corresponding to a creation time of the reference transaction included in the reference transaction, or a timestamp corresponding to a receiving time of the reference transaction included in the reference transaction; and
wherein the timestamp corresponding to the receiving time of the reference transaction is added by a blockchain node associated with the blockchain when the reference transaction is received by the blockchain node.

8. A computer-implemented system for determining time for blockchain data, comprising:
one or more computers; and
one or more computer memory devices interoperably coupled with the one or more computers and having tangible, non-transitory, machine-readable media storing one or more instructions that, when executed by the one or more computers, perform operations comprising:
obtaining a first transaction identifier of a target transaction stored on a blockchain, wherein the target transaction comprises first target data, and wherein the first target data is generated by adding a second transaction identifier of a reference transaction stored on the blockchain to a second target data;
obtaining, based on the first transaction identifier, a first timestamp corresponding to the target transaction;
obtaining, based on the second transaction identifier, a second timestamp corresponding to the reference transaction; and
determining, based on the first timestamp and the second timestamp, a time period during which the second target data was generated.

9. The computer-implemented system of claim 8, wherein the first transaction identifier is a hash value of the reference transaction and the second transaction identifier is a hash value of the target transaction.

10. The computer-implemented system of claim 8, wherein the target transaction comprises a hash value of the first target data, and obtaining the first timestamp comprises:
identifying, based on the first transaction identifier, the target transaction; and
receiving, from a blockchain node associated with the blockchain, the hash value of the first target data and the first timestamp corresponding to the target transaction.

11. The computer-implemented system of claim 10, wherein a local version of the first target data is stored by a data verifier, and obtaining the second timestamp comprises:
calculating a hash value of the local version;
determining that the hash value of the local version is same as a hash value of the first target data;
identify the first transaction identifier from the local version;
identifying, based on the first transaction identifier, the reference transaction stored on the blockchain; and
obtaining the second timestamp corresponding to the reference transaction.

12. The computer-implemented system of claim 8, wherein the time period is between a time of the first timestamp and a time of the second timestamp.

13. The computer-implemented system of claim 8, wherein the first timestamp is one of:
a timestamp corresponding to a creation time of a block that includes the target transaction, a timestamp corresponding to a creation time of the target transaction included in the target transaction, or a timestamp corresponding to a receiving time of the target transaction included in the target transaction; and
wherein the timestamp corresponding to the receiving time of the target transaction is added by a blockchain node associated with the blockchain when the target transaction is received by the blockchain node.

14. The computer-implemented system of claim 8, wherein the second timestamp is one of:
a timestamp corresponding to a creation time of a block that includes the reference transaction, a timestamp corresponding to a creation time of the reference transaction included in the reference transaction, or a timestamp corresponding to a receiving time of the reference transaction included in the reference transaction; and
wherein the timestamp corresponding to the receiving time of the reference transaction is added by a blockchain node associated with the blockchain when the reference transaction is received by the blockchain node.

15. A non-transitory, computer-readable medium storing one or more instructions executable by a computer-implemented system to perform operations for determining time for blockchain data, comprising:
obtaining a first transaction identifier of a target transaction stored on a blockchain, wherein the target transaction comprises first target data, and wherein the first target data is generated by adding a second transaction identifier of a reference transaction stored on the blockchain to a second target data;
obtaining, based on the first transaction identifier, a first timestamp corresponding to the target transaction;
obtaining, based on the second transaction identifier, a second timestamp corresponding to the reference transaction; and
determining, based on the first timestamp and the second timestamp, a time period during which the second target data was generated.

16. The non-transitory, computer-readable medium of claim 15, wherein the first transaction identifier is a hash value of the reference transaction and the second transaction identifier is a hash value of the target transaction.

17. The non-transitory, computer-readable medium of claim 15, wherein the target transaction comprises a hash value of the first target data, and obtaining the first timestamp comprises:
identifying, based on the first transaction identifier, the target transaction; and
receiving, from a blockchain node associated with the blockchain, the hash value of the first target data and the first timestamp corresponding to the target transaction.

18. The non-transitory, computer-readable medium of claim 17, wherein a local version of the first target data is stored by a data verifier, and obtaining the second timestamp comprises:
calculating a hash value of the local version;
determining that the hash value of the local version is same as a hash value of the first target data;
identify the first transaction identifier from the local version;
identifying, based on the first transaction identifier, the reference transaction stored on the blockchain; and
obtaining the second timestamp corresponding to the reference transaction.

19. The non-transitory, computer-readable medium of claim 15, wherein the time period is between a time of the first timestamp and a time of the second timestamp.

20. The non-transitory, computer-readable medium of claim 15, wherein the first timestamp is one of:
a timestamp corresponding to a creation time of a block that includes the target transaction, a timestamp corresponding to a creation time of the target transaction included in the target transaction, or a timestamp corresponding to a receiving time of the target transaction included in the target transaction; and
wherein the timestamp corresponding to the receiving time of the target transaction is added by a blockchain node associated with the blockchain when the target transaction is received by the blockchain node.

21. The non-transitory, computer-readable medium of claim 15, wherein the second timestamp is one of:
a timestamp corresponding to a creation time of a block that includes the reference transaction, a timestamp corresponding to a creation time of the reference transaction included in the reference transaction, or a timestamp corresponding to a receiving time of the reference transaction included in the reference transaction; and
wherein the timestamp corresponding to the receiving time of the reference transaction is added by a blockchain node associated with the blockchain when the reference transaction is received by the blockchain node.
